(19) United States
(12) Patent Application Publication
(10) Pub. No.: US 2024/0052647 A1
(43) Pub. Date: Feb. 15, 2024

(54) CONCRETE SURFACE PROCESSING MACHINES, SYSTEMS, AND METHODS FOR PROCESSING CONCRETE SURFACES

(71) Applicant: HUSQVARNA AB, Huskvarna (SE)

(72) Inventor: Andreas Jönsson, Hallsberg (SE)

(21) Appl. No.: 18/267,493

(22) PCT Filed: Dec. 13, 2021
(86) PCT No.: PCT/SE2021/051240

§ 371 Date: Jun. 15, 2023

(30) Foreign Application Priority Data
Dec. 18, 2020 (SE) 2051496-4

(51) Int. Cl. E04F 21/24; B24B 7/18; B24B 47/10; B24B 49/12

(52) U.S. Cl. CPC E04F 21/245; B24B 7/186; B24B 47/10; B24B 49/12

(57) ABSTRACT

A machine (100) for processing a concrete surface, the machine comprising a control unit (101) and at least three tool carriers (110) arranged to rotate about respective tool carrier axes, wherein at least one of the tool carriers (110) is arranged to generate a variable force acting on the machine, relative to the concrete surface, in response to a control signal generated by the control unit (101), wherein the control signal is configured to provide locomotion by the machine relative to the surface.

### TECHNICAL FIELD

The present disclosure relates to machines for processing concrete and stone surfaces, such as floor grinders and troweling machines. The disclosed machines comprise means for self-locomotion and are suitable for autonomous or remote controlled operation.

### BACKGROUND

Concrete surfaces are commonly used for flooring in both domestic and industrial facilities. The sizes of concrete surface floors range from a few square meters for a domestic garage floor to thousands of square meters in larger industrial facilities. Concrete surfaces offer a cost efficient and durable flooring alternative and have therefore gained popularity over recent years.

Concrete surface preparation is performed in steps. After the concrete is poured, the surface is first troweled and then grinded flat after the surface has reached a sufficient level of maturity. A matured concrete surface can then be polished to a glossy finish if desired. A floor grinder and/or a power trowel machine can be used to process the concrete surface efficiently.

Floor grinders and power trowels range in size but are normally quite bulky. U.S. Pat. No. 7,775,740 B2 discloses an example power trowel for processing larger concrete surfaces. U.S. Pat. No. 6,846,127 B1 discloses an example power trowel for processing smaller and medium sized concrete surfaces. Generally, different types of concrete surface processing tools are used depending on the size of the concrete surface and the concrete processing task at hand.

DE 19542728 C1 relates to a concrete surface processing machine which supposedly is easier to maneuver due to an electronic control unit which compensates for the presence of irregularities, inclines, etc. that may be present on the concrete floor surface.

U.S. Pat. No. 3,936,212 A shows a power trowel where a single power source is fixedly mounted to a frame and connected to three trowels via a complex linkage.

WO 2020102458 A1 shows an autonomous power trowel machine based on two tool carriers.

CN 1598218 A D4 illustrates a four rotor power trowel with a central power source arranged to drive the rotors via mechanical linkage.

There is a need for a more flexible machine system which can be used for both small and large surfaces.

There is also a need for more efficient means of powering the tool carriers on concrete surface processing machines.

### SUMMARY

It is an object of the present disclosure to provide improved concrete surface processing machines and systems for processing concrete surfaces.

This object is obtained by a concrete surface processing machine for processing a concrete surface. The machine comprises a control unit and at least three tool carriers arranged to be driven by respective electric machines. The tool carriers are arranged to rotate about respective tool carrier axes, wherein at least one of the tool carriers is arranged to generate a variable force acting on the machine, relative to the concrete surface, in response to a control signal generated by the control unit, wherein the control signal is configured to provide locomotion by the machine relative to the surface. Thus, the machine is able to move itself around over the concrete surface and at the same time process the concrete surface by, e.g., grinding or troweling. Advantageously, the machine is able to simultaneously move in a forward direction and at the same time rotate about its mass center, which provides, e.g., improved concrete grinding. The machine is controlled by the control unit and does not require an operator to function. Rather, the machine is preferably controlled remotely or operates autonomously to process the concrete surface. The fact that each tool carrier has its own electric machine means that no complex transmission is required from a central power source, such as a chain or belt drive, and that the tool carrier control is simplified, since the electric machines can be controlled independently from each other in terms of, e.g., applied torque or axle speed.

According to a particularly advantageous example, the electric machines are arranged to be tilted together with the tool carriers, i.e., the tool carrier rotates about the same axis as the motor axle of the electric machine. This makes the connection between power source and tool carrier even less complex.

Since each tool carrier is connected to a respective electric machine, the distance between the electric machine and the tool carrier can be made quite short, i.e., on the order of a few centimeters. Thus, drive axles can be designed short and robust, which is an advantage.

According to aspects, a total weight of the machine is less than 30 kg, and preferably no more than 25 kg. This light-weight machine can easily be transported between work sites. For smaller jobs, a single machine can be used, while, for larger jobs, a plurality of machines can be used in combination to process the larger concrete surface. Thus, a flexible and versatile concrete processing system is provided. The machine footprint can be comprised in a square of dimensions 100 cm by 100 cm, i.e., the machine can also be made very compact in terms of size. However, it is also appreciated that many of the ideas discussed herein can also be applied to standard size concrete surface processing machines, such as regular size floor grinders and power trowels. Thus, although the proposed techniques and machines are advantageously used with smaller sized machines, there is nothing preventing use also with larger machines. According to aspects, at least one tool carrier axis is arranged tiltable in one or two dimensions with respect to a base plane of the machine to generate locomotion by the machine relative to the surface, wherein the control unit is arranged to control the tool carrier axis tilt by the control signal. By tilting the tool carrier axis or axes, a stable and robust means for self-locomotion is provided. This form of self-locomotion is also easily controlled by the control unit. Both rotation about the mass center as well as motion in the forward direction can be generated in this manner. As mentioned above, the tool carriers are advantageously connected directly to the motor axle of the respective electrical machine, which machine is then tilted together with the tool carrier. Since the electric machine is arranged to be tilted, the tool carrier being connected directly to the motor axle is then tilted together with the electric machine. Thus, the rotation axis of the tool carrier is aligned with the rotation axis of the electric machine rotor during tilting.

According to aspects, at least two of the tool carrier axes are arranged tiltable with respect to the base plane, wherein respective locomotion forces generated by the at least two corresponding tool carriers are configured to generate a desired torque about a mass center of the machine. This means that the entire machine can be brought into a controlled rotation about its mass center or about a centroid of the machine, which is an advantage since the concrete processing operation if often furthered by this type of planetary rotation. Classic floor grinders often comprise tool carriers arranged to rotate about respective tool carrier axes, and a planetary rotation which rotates the tool carriers about a planetary rotation axis different from the tool carrier axes. This type of machine requires a complex drive arrangement to actuate the different rotations. By instead rotating the entire machine, the planetary drive arrangement is no longer necessary, which is an advantage.

According to aspects, the at least one tool carrier axis is arranged tiltable by a servomechanism connected to an excentre based actuator. The servo mechanism represents a robust actuator suitable for this task, and it is easily controlled by the controlled unit. The servo mechanism provides a high resolution control means, meaning that very small tilt angles can be controlled from the control unit. The servomechanism may of course be arranged to bear on the electric machine to tilt the electric machine along with a tool carrier directly attached to the electric motor axle.

According to aspects, the at least one tool carrier with tiltable axis is supported by a cup spring. The cup spring provides a robust assembly and is also cost-efficient and easy to manufacture.

According to aspects, an electric motor and/or a transmission of the tiltable tool carrier is arranged tiltable with respect to the base plane. By tilting the entire drive mechanism, a cost efficient yet robust design is obtained. The complexity of the tilt mechanism is also reduced. No complex mechanical linkage between tool head and drive motor is necessary since the entire drive package is tilted.

According to aspects, at least one of the tool carriers is configured displaceable along the respective tool carrier axis by the control unit to adjust a normal load associated with the tool carrier. The control unit is arranged to control the displacement of the tool carrier by the control signal to provide locomotion by the machine relative to the surface. This type of self-locomotion principle is cost-efficient and easy to assemble. The tool carrier may also be arranged displaceable in a plane transversal to a base plane of the machine, with similar effect.

According to aspects, at least one of the tool carriers is arranged to rotate with a variable rotational velocity. The control unit is arranged to control the variable rotational velocity of the tool carrier by the control signal to provide locomotion by the machine relative to the surface. Many electric machines available off-the-shelf implement a controllable motor speed. Thus, the control unit can simply interface with the electric motor to adjust tool rotational velocity in a convenient manner. The variable rotational velocity can be configured as a variable electric motor axle speed and/or a variable transmission gear ratio.

According to aspects, the machine comprises four tool carriers arranged in a square configuration about a machine centroid. This square configuration is both stable and at the same time easy to control to obtain a desired self-locomotion.

According to aspects, a first tool carrier is arranged to rotate with a rotational velocity in a different rotation direction compared to a second tool carrier. By using different directions of rotation, the two tool carriers complement each other and thereby provide a machine which is easier to control by the control unit.

According to aspects, the machine comprises one or more rechargeable batteries configured to power one or more electric machines on the machine. These batteries may advantageously be charged inductively. For instance, the machine may comprise an inductive charging circuit arranged to interface with an external power source to recharge the one or more rechargeable batteries. The rechargeable batteries generally provide an efficient machine operation, even at work sites lacking a reliable mains electricity source.

According to aspects, the control unit is arranged to receive the control signal at least in part from an external remote control device and/or from an external system for autonomous drive. The control unit may also be arranged to generate a control signal at least in part as an autonomous drive control signal. It is an advantage that no operator is needed to operate the machine, or at least required to be located close to the machine. This is because the relatively light-weight machine can then process concrete surfaces which are not yet fully matured, i.e., soft. An operator would most likely leave footprints in such surfaces, but now the operator may be located some distance away, or not even be present in vicinity of the concrete surface to be processed. An autonomous system may also process the concrete surface during off-hours.

According to aspects, the machine comprises a control unit with a radio transceiver arranged to establish a communication link to at least one other machine. This way the machine can form a mesh network with other machines, which mech network can be used for collaboration by a group of machines, referred to herein as a swarm, to collaboratively process a larger concrete surface. The mesh network can also be used to relay information between machines in the swarm and from a remote control unit to one or more machines in the swarm.

According to aspects, the machine comprises a cover body with one or more proximity sensors and/or impact sensors configured to detect when the cover body approaches and/or comes into contact with an obstacle. The machine further comprises a control unit arranged to perform a situation avoidance maneuver in response to the one or more sensors detecting proximity and/or contact with the obstacle. This way safety is ensured since the machine will quickly and reliably detect any obstacles in its path. The situation avoidance maneuver may, e.g., be a full stop of the machine. The situation avoidance maneuver may also comprise reversing the machine away along the path it entered into the situation.

According to aspects, the machine comprises an emergency stop control input device arranged accessible on an exterior surface of the machine when the machine is in use. This emergency stop control input device can be used by an operator or technician to disable the machine in case something goes wrong, which is an advantage.

According to aspects, the one or more tool carriers hold tools which are arranged for any of: smoothing a concrete surface, troweling a concrete surface, grinding a concrete surface, or polishing a concrete surface. It is an advantage that the same machine can be used for a wide range of different tasks. For instance, the one or more tool carriers may comprise respective grinding tools arranged for abrasive operation or troweling tools, where each troweling tool comprises a carrier structure arranged to carry trowel blades. The carrier structure and the trowel blades can be designed to be symmetric such that the carrier structure can be rotated in both clock-wise and counter-clockwise directions.

According to aspects, the machine comprises a positioning system arranged to position the machine in a coordinate system relative to the concrete surface. The positioning system facilitates motion control of the machine.

There is also disclosed herein systems and methods for processing concrete surfaces associated with the above-mentioned advantages. In particular, there is disclosed methods for processing a concrete surface comprising deploying a swarm of concrete surface processing machines to collaboratively process the surface.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-C show an example self-propelled floor grinding machine;

FIG. 2 illustrates a principle of machine locomotion;

FIGS. 3A-B schematically illustrates tool head tilt;

FIG. 4 schematically illustrates machine locomotion;

FIG. 5 is a cross-sectional illustration of an example machine;

FIG. 6 illustrates details of an example machine interior;

FIG. 7 shows details of an electric machine for a machine;

FIGS. 8A-B show an example machine;

FIG. 9 illustrates a principle of machine locomotion;

FIG. 10 schematically illustrates a machine system;

FIGS. 11A-B show example remote control devices;

FIG. 11C schematically illustrates a control unit for autonomous control;

FIG. 12 shows an example self-propelled troweling machine;

FIGS. 13A-B illustrate different principles of self-locomotion.

FIG. 14 is a flow chart illustrating methods;

FIG. 15 schematically illustrates a control unit; and

FIG. 16 shows a computer program product;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

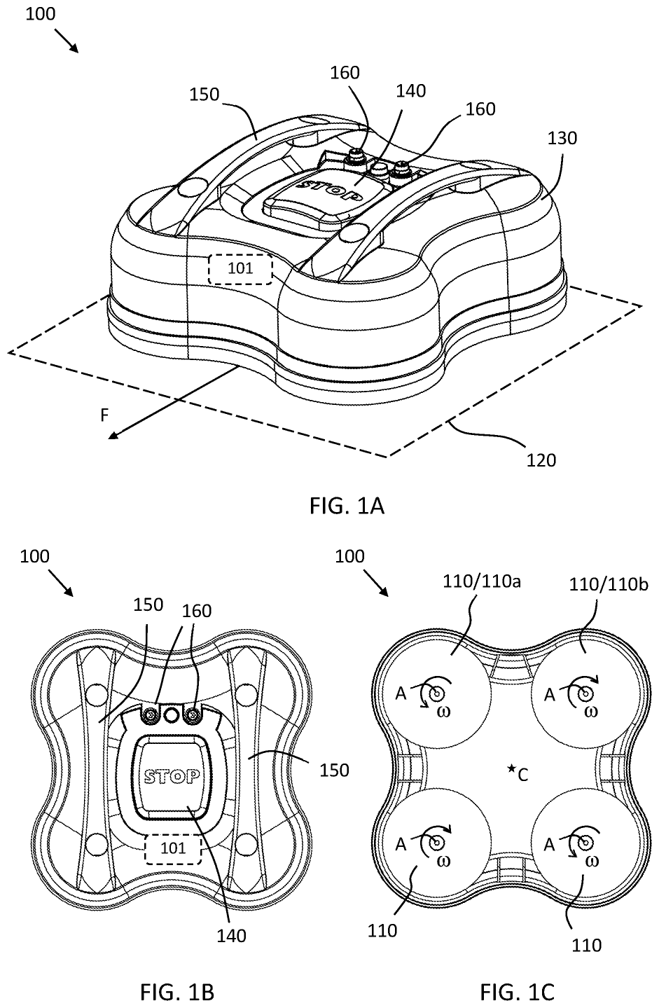

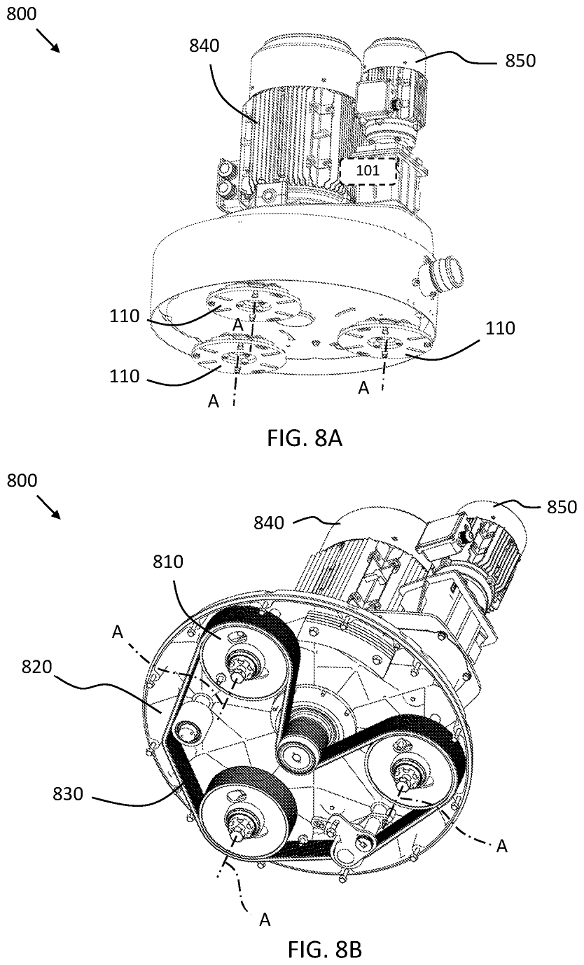

FIGS. 1A-C illustrate a machine 100 for processing concrete surfaces. The machine is supported on the concrete surface by four rotatable tool heads. Each tool head comprises a tool such as a grinding disc or the like, which is held by a tool carrier 110. This particular machine comprises four tool carriers 110 arranged in a square configuration about a machine centroid C. An example comprising three tool carriers will be discussed in more detail below in connection to FIGS. 8A and 8B, and more than four tool carriers can also be used. Some aspects of the present disclosure are also applicable to machines with two tool carriers.

The tool heads arranged to process the concrete surface extend in a base plane 120 of the machine. The base plane coincides with the concrete surface to be processed during operation of the machine 100. In other words, the base plane essentially constitutes the bottom surface of the machine 100.

The machine 100 shown in FIG. 1C is equipped for floor grinding or floor polishing. The tool carriers 110 therefore hold tool heads arranged for abrasive operation, such as diamond tools for abrading the concrete surface. The abrasive tools can be of varying grit for different operations, i.e., course grit for leveling and fine grit for polishing. These tools may also be referred to as grinding heads.

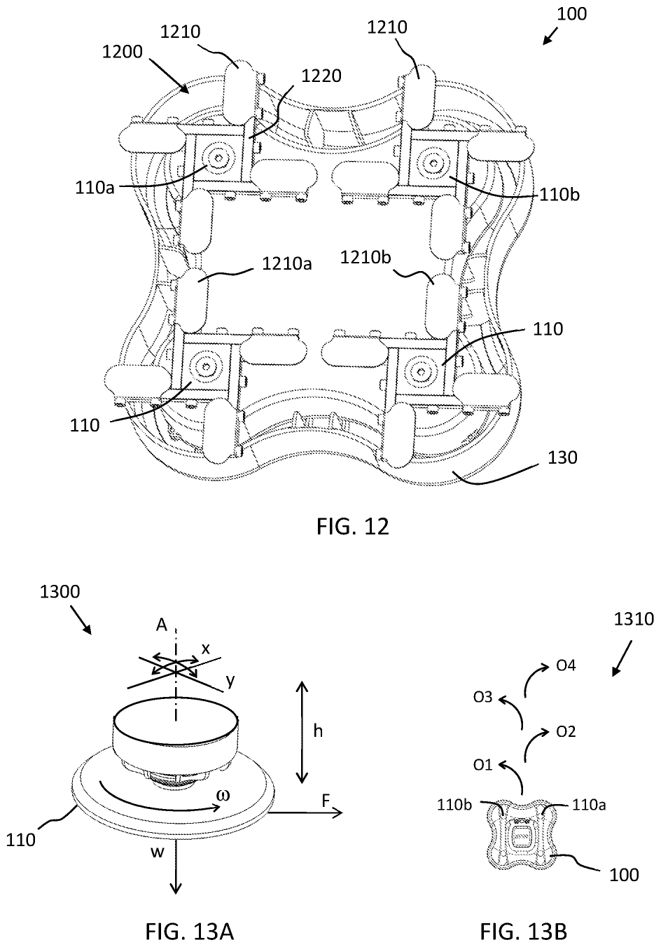

Tool carriers holding tools for a troweling operation, i.e., troweling blades are discussed in connection to FIG. 12 below. Other types of tools may also be carried by the tool carriers. For instance, the tool carriers may hold soft tool heads arranged to just provide self-locomotion by the machine 100 with minimum damage to the concrete surface. These tool heads can be used in a transportation mode of operation, or when surveying the concrete surface by means of sensors arranged on the machine 100, such as radar sensors, vision-based sensors, or lidar sensors. The sensors may be configured to detect any of cracks in the concrete surface, scratch marks in the surface, discoloration, or the like. The sensors may also comprise a surface temperature sensors and/or a moisture sensors, where the control unit is arranged to estimate a degree of maturity of the concrete surface.

In general, a tool carrier is a structure arranged to hold a concrete processing tool such as a grinding disc or a set of troweling blades. A tool carrier with an attached tool may be referred to as a tool head. A grinding head is a tool head arranged for grinding or polishing a concrete surface, while a troweling head is a tool head arranged for a troweling operation.

This particular machine 100 differs from known machines in that it is relatively small in both size and weight and does not comprise any manual control means such as a manual control handle or the like which an operator can use to steer the machine. Instead, this machine is self-propelled and comprises an on-board control unit 101, which control the various operations of the machine without an operator having to go near the machine. The control unit 101 will be discussed in more detail below in relation to FIG. 15. An example machine, like the machine 100 illustrated in FIGS. 1A-C, may be associated with a total weight less than 30 kg, and preferably no more than 25 kg. The machine footprint, i.e., the part of the surface 210 covered by the grinder, is comprised in a square of dimensions 100 cm by 100 cm, and preferably no more than 70 cm by 70 cm. It is, however, appreciated that many of the herein discussed techniques are also applicable with advantage in larger floor grinders and power trowels.

The machines discussed herein may be used for any of smoothing the concrete surface, troweling the concrete surface, grinding the concrete surface, and/or polishing the concrete surface. Thus, the machine 100 with the tool carriers 110 can be used for different types of concrete processing operations, such as troweling and grinding, by a convenient replacement of the tools on the rotatable tool carriers 110.

The tool carriers 110 can also be equipped with soft or resilient discs, such as rubber discs, which are designed to provide self-locomotion with a minimum degree of damage to the concrete surface. These transportation mode discs can be fitted to the machine in case the machine needs to traverse a sensitive concrete surface which has not fully matured yet. The radius of the discs may be configured to be larger than the radius of the grinding tools, to reduce impact to the concrete surface.

The transportation mode discs can also be used by the machine for surveying a concrete surface, i.e., by using one or more sensors configured to measure one or more properties of the concrete surface, such as any of a radar sensor, a vision-based sensor, and/or a lidar sensor configured to detect scratch marks, uneven surface segments, discoloration, or damage in the concrete surface such as cracks.

The one or more sensors may also comprise a surface temperature sensor and/or a moisture sensor, where the control unit is arranged to determine a degree of concrete maturity associated with a segment of the concrete surface. The concrete maturity level can, e.g., be determined from a look-up table indexed by temperature and moisture level, or just moisture.

The machine 100 is light enough to be carried by an operator, e.g., by the handles 150 arranged on the cover body 130 of the machine. This means that the machine is very easy to deploy and can be moved between work-sites in a convenient manner, e.g., in the back of a truck of even a small car.

The machine 100 is preferably although not necessarily battery powered. Electrical connectors 160 can be arranged on the top side of the machine for convenient access by a battery charger cable.

For larger jobs, i.e., to process larger surfaces, a plurality of machines 100 can be used in a floor grinding system. This type of system will be discussed in more detail below in connection to FIG. 10.

The machine 100 optionally comprises a cover body 130 with one or more proximity sensors and/or impact sensors configured to detect when the cover body approaches and/or comes into contact with an obstacle. The machine further comprises a control unit 101, 1500 arranged to perform a situation avoidance maneuver in response to the one or more sensors detecting proximity and/or contact with the obstacle. This sensory system can be configured to halt the machine when it comes into contact with an obstacle, or even before it actually hits the obstacle. Pressure sensors can be used to detect when the body hits an obstacle, while radar sensors and/or ultrasound sensors can be arranged to detect when an obstacle is about to be hit by the machine. The situation avoidance maneuver may comprise bringing the grinder to a stop, or possibly executing an avoidance maneuver to avoid colliding with the obstacle.

For additional safety, the machine 100 may also comprise an emergency stop control input device 140 arranged accessible on an exterior surface of the machine as illustrated in FIGS. 1A and 1B, when the machine is in use. An operator may push this button in case something has gone wrong, which will immediately stop the machine. Of course, emergency stop buttons may also be arranged remote from the machine 100 and connected to the machine via wireless link, e.g., on a remote control for controlling the machine 100.

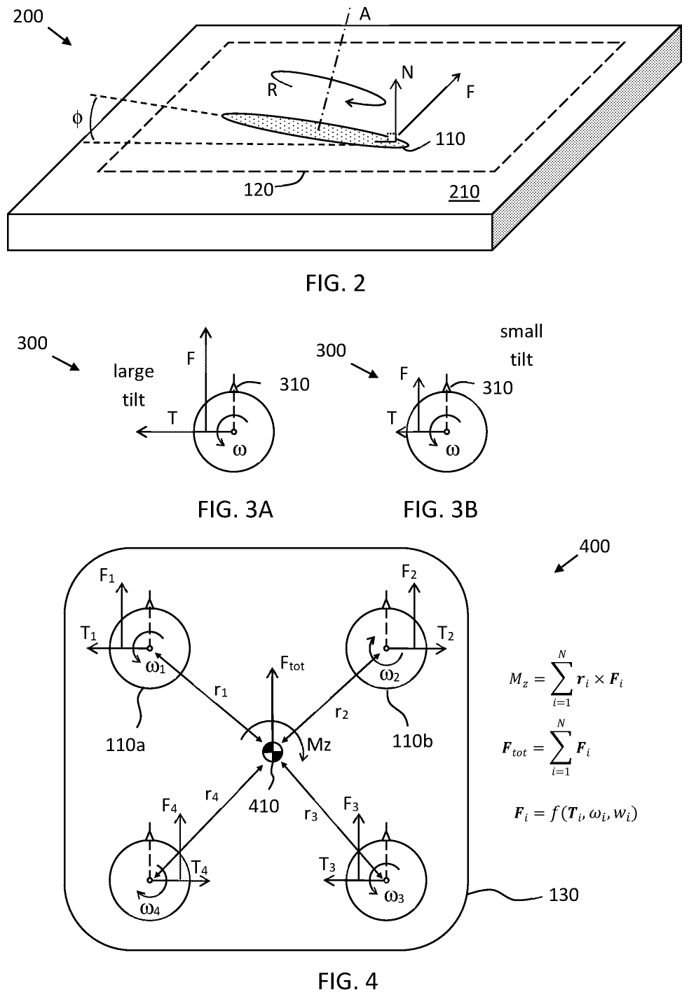

With reference also to FIG. 2, the machine 100 is self-propelled to move in a direction F in a controlled manner. This locomotion is generated by tilting one or more of the tool carrier axles A at an angle ϕ relative to the base plane 120. This tilting generates a difference in normal force N over the tool carrier such that the rotating motion R by the tool carrier 110 generates a force F in a direction perpendicular to the tilting direction.

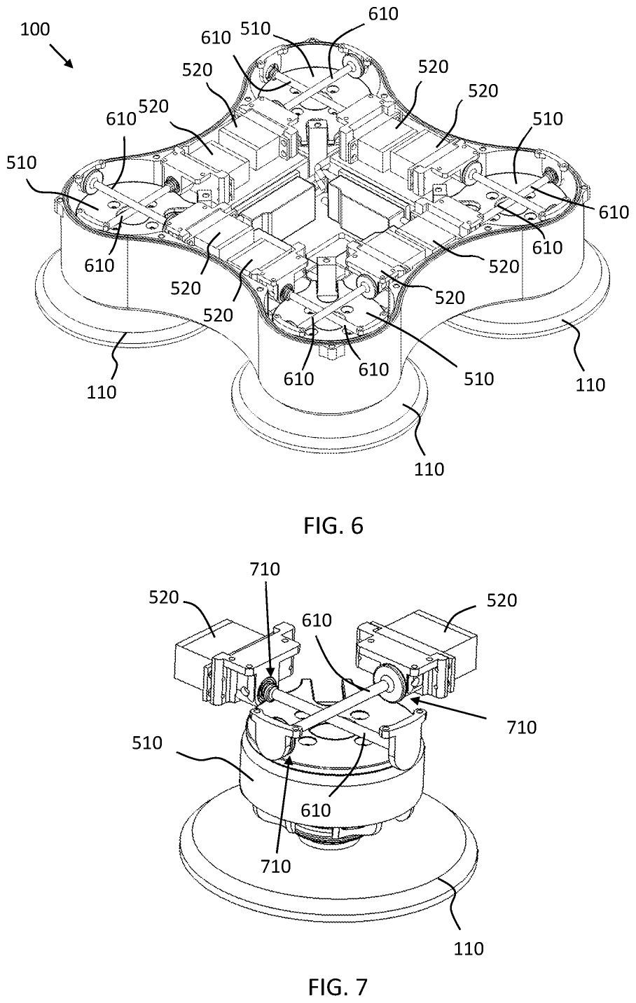

This tilting may be achieved by tilting the entire drive unit, as will be exemplified below in FIGS. 5 and 6. Alternatively, a pulley or the like fixedly connected to the tool carrier 110 can be tilted to obtain the desired effect. An example of this type of system will be discussed below in connection to FIGS. 8A and 8B.

FIGS. 3A and 3B illustrate the tilting principle in more detail. Here, the tilt is illustrated by vector T in two dimensions. The magnitude of the vector T indicates the level of tilt, i.e., the magnitude of the angle ϕ. The generated force F is perpendicular to the direction of the tilt T, and the magnitude of the force depends on the level of tilt, such that a large tilt results in a relatively large force F as shown in FIG. 3A while a smaller tilt, i.e., by a smaller angle, results in a smaller force F. The rotational velocity w also affects the generated force. For most grinding discs, the generated force increases more or less linearly with rotational speed up to a peak where the generated force starts to drop with rotational velocity. The triangles 310 indicate a reference direction of the tilt. The tool head type in use and the maturity level of the concrete, i.e., the friction between tool head and concrete surface also has an effect on the magnitude of the generated force F. The control unit 101 may thus control the generated forces by controlling the direction of the tilt and the magnitude of the tilt by sending control signals to the tilt actuators.

To summarize, FIGS. 1A-C illustrate a machine 100 for processing a concrete surface. The machine comprises a control unit 101 and at least three tool carriers 110 arranged to rotate about respective tool carrier axes A. At least one of the tool carriers 110 is arranged to generate a variable force Fᵢ acting on the machine, relative to the concrete surface. The direction and/or magnitude of the force is generated in response to a control signal by the control unit 101. The control signal is configured to provide locomotion by the machine 100 relative to the surface.

As discussed above, one option for generating locomotion by the machine relative to the concrete surface is if at least one tool carrier axis is arranged tiltable in one or two dimensions with respect to a base plane 120 of the machine. Such tilting can be used to generate locomotion by the machine in a forward direction F, as well as a controlled rotation by the machine relative to the concrete surface about a machine centroid.

This propulsion concept involving tool head tilting is associated with several advantages. For instance, since the forces are generated by tilting, the tool carriers can be arranged to rotate at the same absolute rotational velocity ω. This means that the electric machines can be optimized for a given fixed speed, where no speed control arrangements, or at least no complicated speed control arrangements, are required. Having at least three tool heads provides a level of stability to the machine which makes it suitable for operator-less control such as by remote control or autonomous operation. However, four or more tool heads are preferred since this also simplifies control of the propulsion and increases machine stability further.

Alternatively, or in combination with the tilting, at least one of the tool carriers 110 may be configured displaceable along the respective tool carrier axis by the control unit 101 to adjust a normal load wᵢ associated with the tool carrier. The control unit 101 can then control the displacement of the tool carrier by the control signal to provide locomotion by the machine relative to the surface 210. With reference to FIG. 1C if the weight on, e.g., the upper left grinding disc 110a is larger than the weight on the other grinding discs, then the machine 100 will start to rotate about the upper left grinding disc 110a. If more weight is then transferred onto the upper right grinding disc 110b the rotation center will shift towards the upper left grinding disc and also change direction since the two discs rotate in opposite direction. Now, by repeatedly shifting weight between grinding discs in this manner, locomotion by the machine relative to the concrete surface can be obtained. The control unit 101 controls the displacement of the tool carriers in the vertical direction to obtain the desired motion, e.g., a slow rotation about the centroid of the machine complemented by a controlled forward motion in direction F.

The tool carriers may also be arranged controllably movable in a plane transversal to the base plane 120 between a plurality of positions in response to a control signal generated by the control unit 101. This provides an alternative means for self-locomotion by the machine 100.

At least one of the tool carriers 110 may furthermore be arranged to rotate with a variable rotational velocity ω, and the control unit can be arranged to control the variable rotational velocity ω of the tool head by the control signal to provide locomotion by the machine relative to the surface. It is appreciated that the speed of rotation has a similar effect on the machine force distribution as the normal load on the tool heads. Thus, the control unit 101 can generate a control signal to control rotational velocity and thereby obtain a desired motion by the machine relative to the concrete surface.

The control of tilt, normal load, and rotational velocity will be discussed in more detail below in connection to FIG. 16.

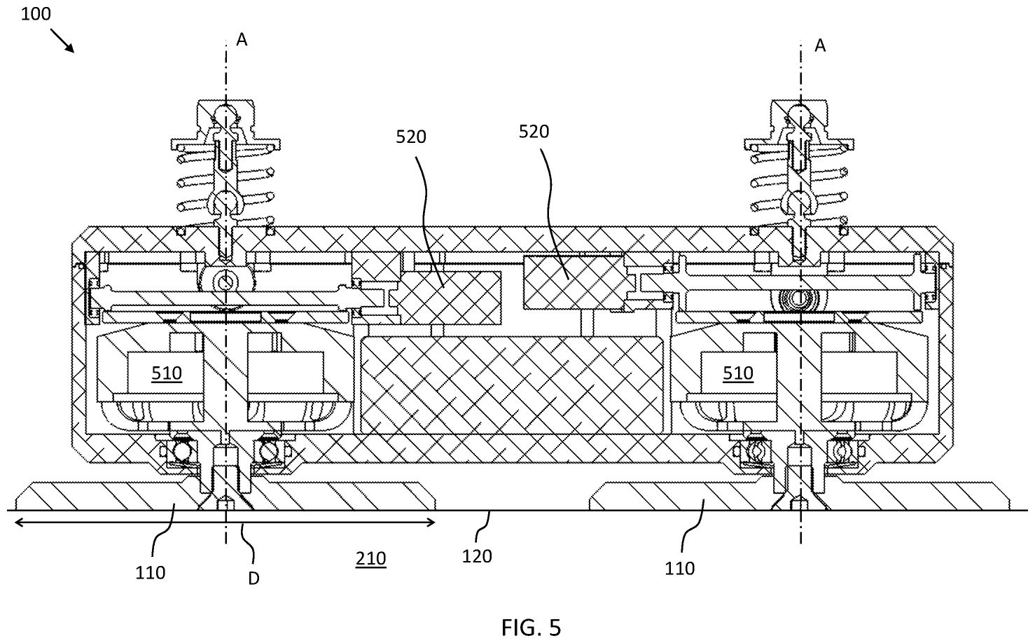

As illustrated in FIG. 4, four tool carrier axes A may advantageously be arranged tiltable T with respect to the base plane 120. This means that four respective locomotion forces F₁, F₂, F₃, F₄ are generated. A combined total force Fₜₒₜₐₗ is generated to provide locomotion and also a torque M_{z} about the machine mass center 410. A particular advantage with the arrangement 400 in FIG. 4 is that the tool heads are arranged in pairs with opposite direction of rotation. The two tool heads in a pair provide a more straight forward motion control since they stabilize each other.

Each force Fᵢ is a two-dimensional vector force in the plane 120. Its direction is, as discussed above, determined from the direction of rotation of the tool head and by the tilt angle T, as well as by the relative load on the tool head compared to other tool heads. The magnitude of the force depends on many different factors. Some of the more important factors include the normal force which depends on the weight wᵢ on the tool head. This normal force can be adjusted in case a variable height suspension system is installed in connection to one or more of the tool heads. Thus, at least one of the tool carriers 110 may be configured with a variable height suspension configured to adjust a normal load wᵢ associated with the tool carrier. The variable height suspension may be controlled by the control unit 1500. This variable height suspension can also be used to calibrate the machine in order to obtain a more stable behavior from the tool head propulsion system. A variable height tool carrier can, for instance, be implemented by mounting the tool carrier on one or more spindles controlled by the control unit 101. Other types of linear actuators are of course also possible to use.

The magnitude of the force also depends on the rotational velocity of the grinding disc as discussed above. The relationship between these factors and the generated force is given by a function

Fᵢ=f(Tᵢ,ωᵢ,wᵢ)

where Tᵢ is the two-dimensional tilt vector representing direction and magnitude of the tilt of the i-th tool head, ωᵢ is the rotational velocity of the i-th tool head, and wᵢ is the weight on the i-th tool head which is indicative of the normal force of the tool head. This function is normally an approximation of the true relationship between parameters and the resulting force. This approximation can be arrived at by, e.g., a combination of analytical derivation and laboratory experimentation. A calibration routine can be carried out in order to adjust the function to match a given device and operating condition.

Generally, rotation about the mass center 410 is generated by the torque M7

$${M}_{z} = {\sum }_{i = 1}^{N} {r}_{i} \times {F}_{i}$$

where N=4 in FIG. 4. A turning motion by the machine can be achieved by varying the forces Fᵢ such that a non-zero torque M_{z} is generated. Thus, turning of the machine, or motion along an arcuate path, can be achieved by varying the set of tilt angles {arg(Tᵢ)}_{i=1, . . . , 4} or the set of tilt magnitudes {|Tᵢ|}_{i=1, . . . , 4} in a controlled manner, and/or by varying rotational velocity {ωᵢ}_{i=1, . . . , 4} and/or by varying normal load {wᵢ}_{i=1, . . . , 4}. It is appreciated that rotational velocity and weight are entirely optional control parameters. Only control of the tilt {Tᵢ}_{i=1, . . . , 4} is required to obtain basic functionality.

The total force Fₜₒₜ (disregarding friction forces and the like) is given by

$${F}_{tot} = {\sum }_{i = 1}^{N} {F}_{i}$$

This quantity determines the direction of motion as well as the speed of the machine. The control unit 101, which will be discussed in more detail below in connection to FIG. 15, can be configured to generate a desired total force to move the machine in a desired direction, and/or a desired torque to rotate the floor grinder by generating one or more control signals to the different actuators on the machine 100. A combination of a non-zero total force and a non-zero torque about the mass center will generate a motion by the machine along an arcuate path. Fₜₒₜ is preferably optimized for a given floor surfacing operation by the control unit 101.

The machines disclosed herein may be associated with different modes of operation. When in a transport mode of operation the machine may be configured by the control unit 101 to move relatively fast along a straight path towards a target destination without rotating about the machine centroid. This mode of operation is preferably used when moving the machine 100 from one place to another place. The transportation mode of operation may be optimized for transporting the machine 100 without leaving marks on the concrete surface, which may not be fully matured.

The machine 100 may also be associated with a work mode or active mode of operation. This mode is used, e.g., when grinding or troweling a concrete surface. The work mode of operation may comprise a rotation about the machine centroid in combination with a forward motion. The work mode of operation may be optimized for grinding performance or for troweling performance.

The force allocation by the control unit can be performed in a number of different ways. One way to perform the force allocation is to solve the system of force equations and torque equations analytically. Another, less computationally intensive, way to perform the force allocation and tool head coordination is to maintain a set of look-up tables (LUT) with suitable tilt values for different operations. Of course, these LUTs may need to be calibrated regularly.

Another, preferred method of force allocation and tool head coordination is to implement a feedback system where one or more sensors are used to detect a current motion behavior by the machine. Such sensors may comprise, e.g., any of inertial measurement units (IMU), electronic compasses, radar transceivers, global positioning system (GPS) and indoor location system transceivers. The control unit can then control the set of tilt angles {arg(Tᵢ)}_{i=1, . . . , 4} and/or the set of tilt magnitudes to obtain a desired motion by the machine. A set of rules can be formulated for how to obtain a desired effect. For instance, to increase speed in the forward direction, an increased tilt can be applied as shown in FIG. 4. To reduce torque about the mass center, i.e., to drive more straight, tilt angles on one side can be changed, or tilt magnitudes on one side can be changed.

Depending on the surface processing task at hand, a limit on maximum allowable tilt angle may be imposed. This is because too large tilt angles may generate marks in the concrete surface, which of course is undesired.

FIG. 5 shows a cross-sectional view of the machine 100 in FIGS. 1A-C. The one or more tool carriers are preferably supported by means of a cup spring arrangement which permits tilting of the tool carrier central axes A, which in this example coincides with the motor axle since the tool carrier 110 is attached directly to the motor axle. Two separate electrical machines 510 are shown in FIG. 5. Each electric machine drives one respective tool carrier. This is an advantage since no complicated transmission, such as a belt drive or the like, is required. The tool carrier axes are arranged tiltable T by a servomechanism 520 connected to an excentre based actuator 610 shown in more detail in FIG. 6.

The tool carriers 110 are arranged to be driven by respective electric machines 510. The axles of the electric machines 510 may in general either be directly connected to the tool carriers 110, or via some intermediate arrangement. It is an advantage that the electric machines 510 can be controlled independently from each other by the control unit 101, since there is no need for a complex transmission linking a central power source to the different tool carriers which allows separate control of the tool carriers. For instance, the control unit 101 can control the speed of rotation of one tool carrier without also controlling the other tool carriers by simply controlling the relevant electric machine and not the others. Different applied torques on the different tool carriers can also be generated in a straight forward manner, due to the separate and independently controllable electric machines.

Note that the electrical motors 510 are arranged relatively close to the tool carriers 110. This is an advantage from a mechanical robustness point of view. According to an example, the distance between the tool carrier 110 and its respective electrical machine is below one half of the tool carrier diameter D. This distance may, e.g., be below 5 cm for a small machine and below 30 cm for a larger machine.

The motor axles of the electric machines 510 are axially aligned with the respective axles of rotation of the tool carriers 110.

The electrical machines located remote from a central machine location may be connected to the control unit 101 via power cables arranged to power the electrical machine directly, or via respective control cables that terminate in separate control units for each electrical machine. Such cables are much more easy to route compared to a complex transmission involving belts and pulleys, or chains and sprockets.

The electrical machines 510 may as mentioned above be arranged tiltable along with the tool carriers, or fixedly mounted to a frame of the machine, in which case the tool carriers are arranged tiltable by a separate arrangement.

It is noted that the drive arrangement comprising separate and independently controllable electric machines discussed herein can also be applied to standard size floor grinders and power trowels. Thus, the drive arrangements are not limited in use to smaller sized machines, although they may be particularly suitable for use with such smaller size concrete surface processing machines such as the machine 100 discussed above in connection to FIGS. 1A-C.

FIG. 6 illustrates details of an interior of the machine 100. Each tool carrier and tool head is tiltable in two dimensions by two servomechanisms 520 connected to excentre based actuators 610. In this case the excentre based actuators engage the electric machines, but it is also possible to arrange, e.g., a ball joint in-between the motor axle and the tool carrier, and let the servomechanisms act on the tool carrier without tilting the electric machine.

As one of the servos turn its respective axle, the excentre member forces the tool head to tilt at an angle determined by the amount of servo actuation. Note that significant space is now available for different types of components, such as batteries and control units, due to the lack of a transmission from a central power source out to the tool carriers 110. In fact, the complex mechanical linkages seen in the prior art has now been replaced by an electrical cable, which is much more easy to route from the control unit 101 to the electrical machine.

FIG. 7 illustrates an example tilting arrangement in more detail. The excentre wheels 710 are slightly asymmetrical such that a tilting action is generated by turning on the respective axle. The excentre wheels 710 are supported on a track on top of the electric machine 510. Both the eccentric wheel and the track are formed in a durable material to be able to withstand mechanical stress. For instance, hardened steel at Rockwell HRC between 45-57, and preferably between 50-55 may be suitable. FIG. 7 provides an example of a drive mechanism where an electric machine 510 is arranged tiltable along with the tool carrier. The motor axle and the axis of rotation of the tool carrier are aligned in the example of FIG. 7 also during tilting of the tool carrier.

Generally, according to the present disclosure, an axle of an electric machine may be fixedly attached to a tool carrier. A tilt of the electric machine will then translate into a corresponding tilt by the tool carrier, while a rotation of the motor axle will cause a corresponding rotation of the tool carrier. This is an advantage since there is no need for a joint in-between the electric motor axle and the tool carrier.

Of course, different types of bearings may also be contemplated to support the excentre wheels on the track.

The machines discussed herein may be powered by one or more rechargeable batteries configured to power one or more electric machines 510 on the machine 100. These batteries may advantageously be charged using an inductive charging circuit arranged to interface with an external power source and to recharge the one or more rechargeable batteries. For instance, a coil may be embedded directly into the concrete surface which is to be processed by the machine. An example of such a power source 1040 will be discussed in more detail below in connection to FIG. 10. The machine can then access the power source as needed, much like an automated lawn mower.

FIGS. 8A-B illustrate another example machine 800 where at least some of the herein disclosed techniques may be used with advantage. This machine comprises three tool carriers 110, but versions with four or more tool carriers are also possible. The tool carriers 110 are arranged to be driven by a central electric machine 840 (a first motor) via a belt, chain, or gear drive arrangement 830. The first motor 840 is here shown as an electric machine, although a combustion engine can also be used. The entire bottom structure, often referred to as the “planet” 820, is rotated by a second motor 850. This type of dual drive machines is previously known and will therefore not be discussed in more detail herein.

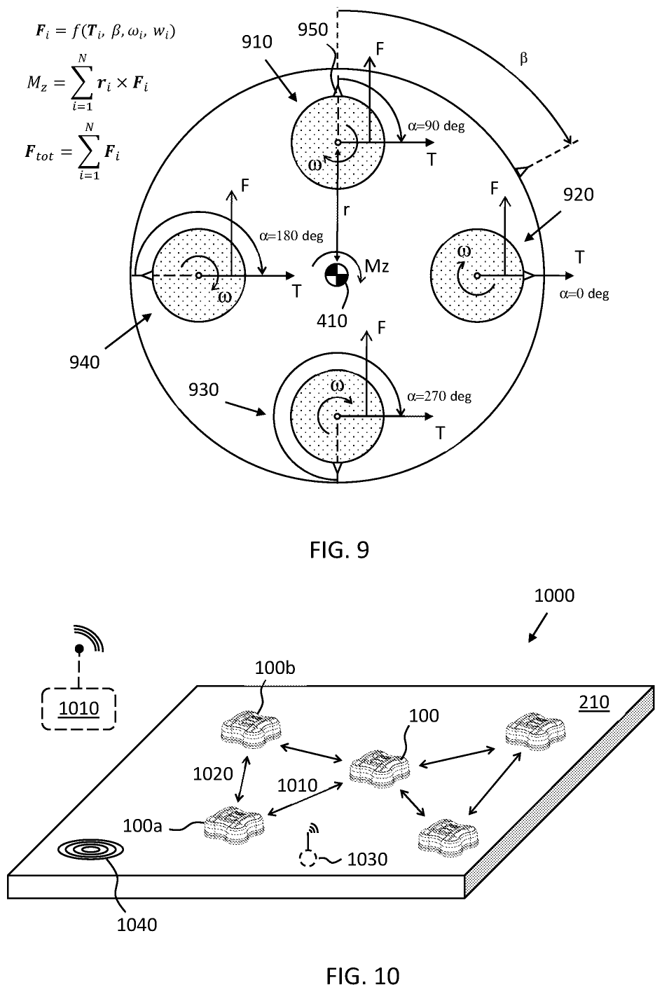

The machine 800 comprises three tool carriers 110 arranged to rotate about respective tool carrier axes A, wherein at least one tool carrier axis is arranged tiltable in two dimensions with respect to a base plane of the machine to generate locomotion by the machine relative to the surface. This tilting can be achieved, e.g., by using a set of servomechanisms and excentre members as discussed above to tilt the pulleys 810. However, the control of the tilting is a bit more advanced compared to the example discussed above in connection to FIG. 4, since the rotation angle β of the planet must also be accounted for. The tilt control concept is illustrated in FIG. 9, where a single tool head is rotated one revolution on the planet. The triangle 950 indicates a reference direction of the tool head.

At a first planet angle 910 β=0, the tilt angle T should be 90 degrees in order to generate a force F pointing upwards in FIG. 9. As the planet rotates, the tilt angle must be adjusted according to the current rotation angle β of the planet. After some time the tool head reaches a second location 920, where the tilt angle has been compensated for the rotation of the planet to maintain the force F pointing in the same direction as before. The tilt angle has been adjusted continuously to account for the rotation of the planet, such that the generated force is maintained in the same direction. After yet some time the tilt angle has been adjusted as shown in position 930, and then in position 940.

This example assumes that a second motor 850 is arranged to generate the planetary motion. However, the tool heads themselves can also be used to generate an arbitrary planetary motion by a machine. In this case, the tilt angles are determined in order to generate a non-zero torque M7 which generates the desired planetary motion.

In general, a control unit 1500 such as the control unit 101 can be configured to distribute forces over the tool heads to obtain a desired motion by the machine, e.g., a given speed in a given direction, perhaps complemented by a non-zero torque to obtain a planetary motion by the machine. The control unit 1500 then considers the following relationships

$$\begin{matrix}{M}_{z} = {\sum }_{i = 1}^{N} {r}_{i} \times {F}_{i} \\ {F}_{tot} = {\sum }_{i = 1}^{N} {F}_{i}\end{matrix}$$

and determines a solution comprising a distribution of forces. Given a distribution of forces {Fᵢ}, the control unit 1500 then configures tool head parameters comprising tilt angle Tᵢ, and optionally also β, ωᵢ, wᵢ

Fᵢ=f(Tᵢ,β,ωᵢ,wᵢ)

where β may be a function of time, ωᵢ is a rotational velocity of the i-th tool head, and wᵢ is a weight associated with the i-th tool head which can be adjusted by, e.g., controlling a variable height suspension system of a tool head. It is appreciated that rotational velocity and weight are entirely optional control parameters. Only control of the tilt {Tᵢ}_{i=1, . . . , 3} is required to obtain basic functionality.

The planetary motion may be generated in either clock-wise or counter-clockwise direction depending on the force allocation {Fᵢ}_{i=1, . . . , 3} and tool head coordination. The planetary motion is preferably complemented by a forward motion by the machine 800 to move across the concrete surface as it grinds the concrete surface in a controlled manner.

FIG. 10 illustrates an example concrete surface processing system 1000 comprising a plurality of machines 100, 800 according to the above discussion. The plurality of machines may be of the same type, i.e., either small machines such as the machine 100, or larger machines such as the machine 800. However, additional advantages may be obtained if a combination of different machines are used to process a larger concrete surface. The smaller machines may then process areas which require a lot of maneuvering, and which may be hard to access for the larger machines, while the larger machines may perform tasks where larger size is an advantage.

One or more of the machines may be configured with transportation mode tool heads allowing the machine to traverse segments of the concrete surface which have not yet matured enough for processing. These machines may then act as scouts, surveying the concrete surface, and reporting back to the other machines when a sufficient level of maturity has been reached on a given concrete segment for a given concrete processing operation.

The machines may comprise a control unit 1500 with a radio transceiver arranged to establish a communication link 1010 to at least one other machine 100a, 100b. This way the plurality of machines can form a mesh network in order to exchange information and perform arbitration in case of any control conflicts which arise.

The plurality of machines may also be communicatively coupled, e.g., by wireless radio link, to a central control unit 1010 arranged to control a floor grinding operation over a concrete surface 210. This central control unit 1010 may control the “swarm” of machines to complete a larger floor grinding task.

The machines may furthermore comprise a positioning system arranged to position the respective machines in a coordinate system relative to the concrete surface 210. This positioning data can be used by the external control unit 1010 in order to control the floor processing operation.

The control units 101 on the machines are arranged to control a tilt T of the at least one tiltable tool carrier 110 in response to a control signal to generate a desired locomotion by the machine relative to the surface 210.

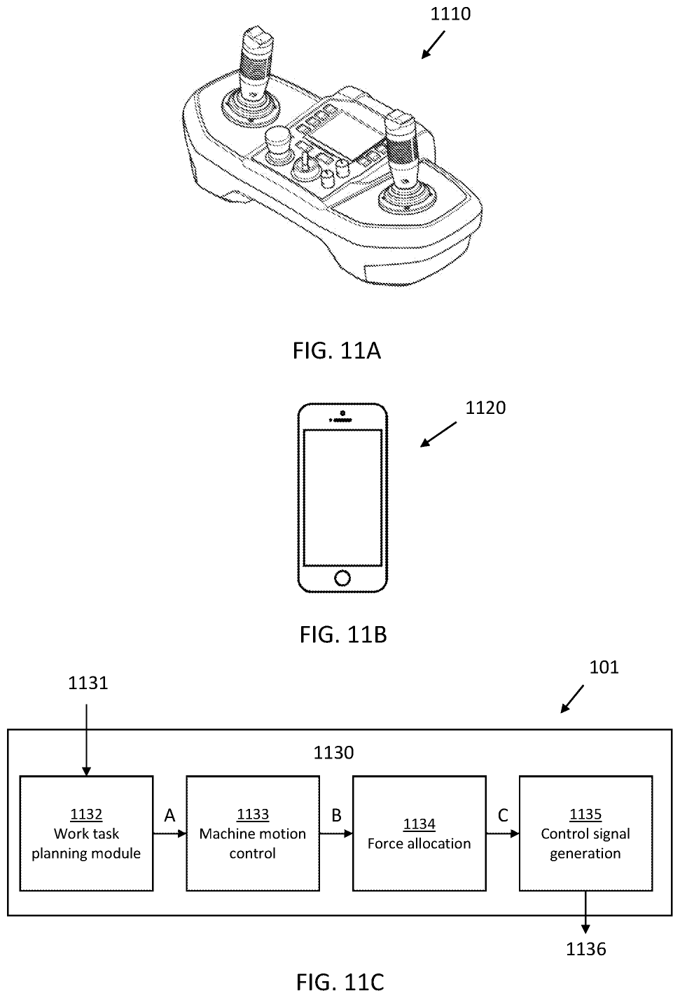

According to some aspects, the machines are arranged to receive the control signal from an external remote control device 1110, 1120, as exemplified in FIGS. 11A and 11B.

According to some other aspects, the machines are arranged to receive the control signal from an external system for autonomous drive 1500. This type of system may, e.g., be implemented in the external control unit 1010.

According to some other aspects, the machines comprise control units 1500 arranged to generate the control signal as an autonomous drive control signal.

An inductive charging station 1040 may be embedded into the concrete surface. The machines 100, 100a, 100b may then regularly return to the charging station to replenish the energy storage, i.e., charge the on-board batteries.

One or more concrete maturity sensors 1030 may also be embedded into the concrete surface. This sensor measures, e.g., temperature and moisture in the concrete slab and is thus able to determine a current concrete maturity level of the concrete surface 210. Based on a time sequence of data samples, the maturity sensor, or the control unit 1010, may extrapolate to estimate a future concrete maturity level over the concrete surface. This allows the swarm of machines to work where it is as most efficient given the maturity levels over the concrete surface.

FIGS. 11A and 11B illustrate example remote controls which can be used to control the different machines 100 discussed herein. The remote control device 1110 is a conventional remote control device which connects to the control unit 101 of the machine 100 via wireless radio link. The remote control device 1120 in FIG. 11B is a tablet or smartphone which connects to the control unit 101 to issue control commands and to receive status reports and other information back from the control unit 101.

FIG. 11C shows an example 1130 of a control unit 101 configured to autonomously control the machine 100. This control unit implements a number of different software modules 1132, 1133, 1134, 1135 which may be executed on the same processing circuitry or distributed on more than one processing platform. Some of the function may also be executed remotely from the machine 100, e.g., on a remote server accessible from the machine 100 via wireless link.

The control unit 101 is arranged to receive a work task instruction from an operator. The work task comprises an instruction describing a given work task or a sequence of work tasks to be performed in an area over a concrete surface. The work task may, e.g., comprise an instruction to grind a given area of a concrete surface to a specified flatness, or to trowel a recently poured concrete slab until a given evenness has been obtained. The work task may comprise a map of the concrete surface, and potentially also a key to enable the machine to start executing. By requiring a key, unauthorized use of the machine 100 can be prevented. The key may, e.g., comprise a password or an encrypted certificate.

The work task planning module 1132 is configured to plan the task. This may, e.g., comprise determining a sequence of operations to be performed by the machine, possibly in cooperation with other machines as discussed in connection to FIG. 10. For instance, the work task planning module may determine a start time for commencing a concrete processing operation in dependence of a maturity level of the concrete surface. The work task planning module 1132 may also coordinate a plurality of machines to complete a given concrete processing task in a collaborative manner.

The work task plan A is then sent to a machine motion control module 1133. This machine motion control module, in a low complex implementation, may just determine a path, speed, and rotational velocity, to be followed by the machine as it processes the concrete surface. More advanced forms of motion control modules may coordinate motion by several machines 100, as shown in FIG. 10, to process larger concrete surfaces. Such coordinated processing may be advantageous if the work task involves a troweling operation, which may require a larger number of machines 100 to move concrete around on the concrete surface from one area to another area. The motion control module 1133 generates a path and a motion characteristic B to be followed by the machine 100 as it completes the processing task.

The force allocation module 1134 receives the path data B and generates a force allocation {Fᵢ} C to be generated by the tool heads as function of time in order for the machine 100 to follow the planned path and a motion characteristic B. This force allocation can be done according to a look-up table where certain motions by the machine 100 can be translated into required forces. The force allocation 1134 may also comprise more advanced machine learning algorithms which have been trained to generate a force allocation which results in a desired motion by the machine 100.

The control signal generation module 1135 receives the force allocation and translates this force allocation into physical control signals to control the tool carriers 110. The resulting control signal or control signals 1136 are then sent to the different actuators in the machine 100.

FIG. 12 illustrates a machine 100 arranged for troweling operations. The tool carriers 110 on this machine holds respective troweling tools 1200, where each troweling tool comprises a carrier structure 1220 arranged to carry trowel blades 1210. In this particular example, the carrier structure and the trowel blades are symmetric such that the carrier structure 1220 can be rotated in both clock-wise and counter-clockwise directions by a simple reconfiguration of the troweling blades 1210. To change the direction of rotation, the troweling blades are detached from the carrier structure and mounted in reverse configuration. The upper left tool carrier 110a has troweling blades 1210 mounted for clockwise rotation, while the tool carrier 110b has troweling blades 1210 mounted for counter-clockwise rotation.

Troweling blades 1210 may be attached to the carrier structure 1220 by threaded fastening members such as bolts, or by quick-release mechanisms such as excentre locks or the like.

FIG. 13A illustrates some different principles 1300 by which a tool carrier 110 can be used to generate a variable force acting on the machine 100, relative to the concrete surface 210, in response to a control signal generated by the control unit 101. It is appreciated that these principles are applicable both for tool carriers holding abrasive tools, i.e., grinding heads, as well as for tool carriers holding troweling blades.

A first principle of self-locomotion is based on tilting the tool carrier axis A. This generates a forward thrust as explained above in connection to FIG. 2. The tilting can be performed in one or two dimensions, i.e., the tilt can be with respect to one tilt axis x, or two tilt axes x, y. By tilting the machine 100 can be made to move forward in a straight line and/or to rotate about a machine centroid. When the machine is operated in a transport mode of operation, motion along a straight line may be preferred, while grinding and troweling operations may be best performed when the forward motion is combined with a controlled rotation of the whole machine about its centroid.

Although tilting of the tool heads may provide the most accurate self-locomotion control, other principles of self-locomotion certainly also exist. A second such principle relies on varying a normal force acting on the tool head 110, which can be achieved by varying the weight on a given tool head. The tool carrier 110 may, e.g., be mounted on a spindle or the like which allows repositioning the tool head vertically h along the tool carrier axis A. By moving the tool head downwards towards the concrete surface, more load is transferred onto the tool head. Conversely, by moving the tool head upwards away from the concrete surface, load is transferred away from the tool carrier 110. With reference to FIG. 13B, by repeatedly shifting load between, e.g., two of the tool carriers 110a, 110b, the machine can be made to move forward in an oscillating manner O1, O2, O3, O4. Each time load is transferred onto a given tool head; the machine starts to rotate about a center of rotation shifted towards the tool head with increased load. This way the control unit 101 can control the tool heads to obtain a desired motion by the machine 100.

By a third principle of self-locomotion, the rotational velocity w is changed over the different tool heads by the control unit. A difference in speed of rotation generates an effect similar to that of a variable heigh h. Thus, the control unit 101 is able to generate a desired oscillating motion by the machine 100.

It is appreciated that the control unit 101 may combine all of the above-mentioned principles of self-locomotion. For instance, variation in tool carrier height h and/or speed w can be used to obtain a desired oscillating motion by the machine 100, or to calibrate a forward motion control system, while the tool carrier tilt principle can be used as the main principle of self-locomotion.

It is also appreciated that different principles of self-locomotion may be desired for different concrete processing tasks.

The tool carriers may also be arranged movable in a plane transversal to the base plane 120 shown in FIG. 1A. This mechanism provides a means for distributing weight between the tool heads on the machine. Thus, there is also disclosed herein a concrete surface processing machine 100, 800 for processing a concrete surface 210. The machine comprises a control unit 101 and at least three tool carriers 110 arranged to rotate about respective tool carrier axes A, wherein at least one of the tool carriers 110 is also arranged controllably movable in a plane transversal to a base plane 120 between a plurality of positions in response to a control signal generated by the control unit.

Also, as mentioned above, the disclosed self-propelling arrangements enable a controlled rotation of the machine as it processes the concrete surface. Thus, there is disclosed herein a concrete surface processing machine 100, 800 for processing a concrete surface 210. The machine comprises a control unit 101 and at least three tool carriers 110 arranged to rotate about respective tool carrier axes A, wherein the tool carrier axes define corners of an area between the axes and parallel to the base plane 120, wherein the machine is arranged controllably rotatable about a machine rotation axis intersecting said area by controlling the rotation and/or position of at least one tool carrier in response to a control signal generated by the control unit.

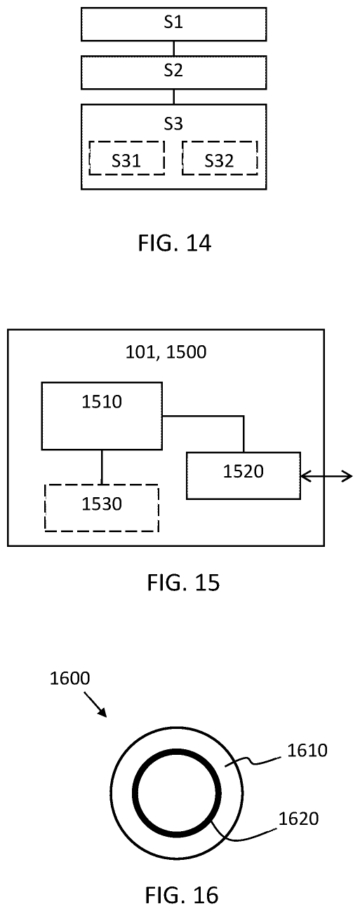

FIG. 14 is a flow chart illustrating a method for processing a concrete surface 210, the method comprises:

configuring S1 a plurality of concrete surface processing machines 100, 800, according to the above discussion, i.e., where each machine comprises a control unit 101 and at least three tool carriers 110 arranged to be driven by respective electric machines and arranged to rotate about respective tool carrier axes A, wherein at least one of the tool carriers 110 is arranged to generate a variable force Fᵢ acting on the machine, relative to the concrete surface 210, in response to a control signal generated by the control unit 101, wherein the control signal is configured to provide locomotion by the machine relative to the surface 210,

deploying S2 the plurality of machines over the concrete surface 210, and

processing S3 the concrete surface 210 by the plurality of machines.

According to some aspects, the processing comprises controlling S31 the plurality of machines by remote control 1110, 1120.

According to some other aspects, the processing comprises autonomously controlling S32 each machine.

The machines 100, 800 disclosed herein can also be used for processing other types of floor surfaces, such as wooden floor surfaces, vinyl floor surfaces, and linoleum floor surfaces. Sanding discs can be fitted onto the tool carriers 110 in order to provide a sanding function by the machines 100, 800. Also, polishing tools can be attached to the tool carriers in order to polish the floor surfaces.

Thus, there is disclosed herein methods for processing a floor surface. The methods comprise:

configuring S1 one or more floor surface processing machines 100, 800, where each machine comprises a control unit 101 and at least three tool carriers 110 arranged to rotate about respective tool carrier axes A, wherein at least one of the tool carriers 110 is arranged to generate a variable force Fᵢ acting on the machine, relative to the floor surface, in response to a control signal generated by the control unit 101, wherein the control signal is configured to provide locomotion by the machine relative to the floor surface,

deploying S2 the one or more machines over the floor surface, and

processing S3 the floor surface by the one or more machines.

It is noted that the principles of self-locomotion discussed herein can also be applied when processing other types of surfaces, i.e., they are not limited to concrete surface processing.

FIG. 15 schematically illustrates, in terms of a number of functional units, the general components of a control unit 101, 1500. Processing circuitry 1510 is provided using any combination of one or more of a suitable central processing unit CPU, multiprocessor, microcontroller, digital signal processor DSP, etc., capable of executing software instructions stored in a computer program product, e.g. in the form of a storage medium 1530. The processing circuitry 1510 may further be provided as at least one application specific integrated circuit ASIC, or field programmable gate array FPGA.

Particularly, the processing circuitry 1510 is configured to cause the device 180 to perform a set of operations, or steps, such as the methods discussed in connection to FIG. 9 and the discussions above. For example, the storage medium 1530 may store the set of operations, and the processing circuitry 1510 may be configured to retrieve the set of operations from the storage medium 1530 to cause the device to perform the set of operations. The set of operations may be provided as a set of executable instructions. Thus, the processing circuitry 1510 is thereby arranged to execute methods as herein disclosed.

The storage medium 1530 may also comprise persistent storage, which, for example, can be any single one or combination of magnetic memory, optical memory, solid state memory or even remotely mounted memory.

The device 1500 may further comprise an interface 1520 for communications with at least one external device. As such the interface 1520 may comprise one or more transmitters and receivers, comprising analogue and digital components and a suitable number of ports for wireline or wireless communication.

The processing circuitry 1510 controls the general operation of the control unit 1500, e.g., by sending data and control signals to the interface 1520 and the storage medium 1530, by receiving data and reports from the interface 1520, and by retrieving data and instructions from the storage medium 1530.

The control unit 101, 1500 may be configured to perform all of the functions discussed above, e.g., in relation to controlling tilt angles and the like to move the machines in relation to a concrete surface.

FIG. 16 illustrates a computer readable medium 1610 carrying a computer program comprising program code means 1620 for performing the methods illustrated in FIG. 14, when said program product is run on a computer. The computer readable medium and the code means may together form a computer program product 1600.

1. A concrete surface processing machine for processing a concrete surface, the machine comprising a control unit and at least three tool carriers arranged to rotate about respective tool carrier axes, wherein at least one of the tool carriers is arranged to generate a variable force acting on the machine, relative to the concrete surface, in response to a control signal generated by the control unit, wherein the control signal is configured to provide locomotion by the machine relative to the surface, wherein the tool carriers are arranged to be driven by respective electric machines.

2. The machine according to claim 1, wherein at least one tool carrier axis is arranged tiltable in one or two dimensions with respect to a base plane of the machine to generate locomotion by the machine relative to the surface, wherein the control unit is arranged to control the tool carrier axis tilt by the control signal, or
wherein at least two of the tool carrier axes are arranged tiltable with respect to the base plane, wherein respective locomotion forces generated by the at least two corresponding tool carriers are configured to generate a desired torque about a mass center of the machine.

3. (canceled)

4. The machine according to claim 2, wherein the at least one tool carrier axis is arranged tiltable by a servomechanism connected to an excentre based actuator.

5. The machine according to claim 2, wherein the at least one tool carrier with tiltable axis is supported by a cup spring, or
wherein an electric motor and/or a transmission of the tiltable tool carrier is arranged tiltable with respect to the base plane.

6. (canceled)

7. The machine according to claim 1, wherein at least one of the tool carriers is configured displaceable along the respective tool carrier axis by the control unit to adjust a normal load associated with the tool carrier, wherein the control unit is arranged to control the displacement of the tool carrier by the control signal to provide locomotion by the machine relative to the surface.

8. The machine according to claim 1, wherein at least one of the tool carriers is arranged to rotate with a variable rotational velocity, wherein the control unit is arranged to control the variable rotational velocity of the tool carrier by the control signal to provide locomotion by the machine relative to the surface, and
wherein the variable rotational velocity is configured as a variable electric motor axle speed and/or a variable transmission gear ratio.

9. (canceled)

10. The machine according to claim 1, comprising four tool carriers arranged in a square configuration about a machine centroid.

11. The machine according to claim 1, wherein a first tool carrier is arranged to rotate with a rotational velocity in a different rotation direction compared to a second tool carrier.

12. The machine according to claim 1, wherein a total weight of the machine is less than 30 kg, or
wherein the machine footprint is comprised in a square of dimensions 100 cm by 100 cm.

13. (canceled)

14. The machine according to any previous claim 1 wherein the tool carriers are arranged to be driven by respective electric machines or wherein the tool carriers are arranged to be driven by a central electric machine via a belt, chain, or gear drive arrangement.

15. (canceled)

16. The machine according to any previous claim 1, comprising one or more rechargeable batteries configured to power one or more electric machines on the machine, and comprising an inductive charging circuit arranged to interface with an external power source and to recharge the one or more rechargeable batteries.

17. (canceled)

18. The machine according to claim 1, wherein the tool carriers are arranged to be driven by a central combustion engine via a belt, chain, or gear drive arrangement, or
wherein the control unit comprises a radio transceiver arranged to establish a communication link to at least one other machine.

19. The machine according to claim 1 wherein the control unit is arranged to receive the control signal at least in part from an external remote control device, or
wherein the control unit is arranged to generate the control signal at least in part as an autonomous drive control signal, or
wherein the machine is arranged to receive the control signal at least in part from an external system for autonomous drive.

20-22. (canceled)

23. The machine according to claim 1, comprising a cover body with one or more proximity sensors and/or impact sensors configured to detect when the cover body approaches and/or comes into contact with an obstacle, the machine further comprising a control unit arranged to perform a situation avoidance maneuver in response to the one or more sensors detecting proximity and/or contact with the obstacle, or
comprising an emergency stop control input device arranged accessible on an exterior surface of the machine when the machine is in use.

24. (canceled)

25. The machine according to any previous claim 1, wherein the one or more tool carriers (mare arranged for holding a tool configured for any of: smoothing a concrete surface, troweling a concrete surface, grinding a concrete surface, polishing a concrete surface, grinding a wooden surface, polishing a floor, or for transporting the machine across the surface with minimum damage to the surface.

26. The machine according to claim 1, wherein the one or more tool carriers hold respective grinding tools arranged for abrasive operation, or
wherein the machine comprises a positioning system arranged to position the machine in a coordinate system relative to the concrete surface.

27. The machine according to claim 1, wherein the one or more tool carriers hold respective troweling tools, wherein each troweling tool comprises a carrier structure arranged to carry trowel blades and
wherein the carrier structure and the trowel blades are symmetric such that the carrier structure can be rotated in both clock-wise and counter-clockwise directions.

28-30. (canceled)

31. The machine according to claim 1, wherein the machine comprises one or more sensors configured to measure one or more properties of the concrete surface, and
wherein the one or more sensors comprise any of: a radar sensor, a vision-based sensor, and/or a lidar sensor configured to detect any of: scratch marks, uneven surface segments, discoloration, or damage in the concrete surface such as cracks, or
wherein the one or more sensors comprise a surface temperature sensor and/or a moisture sensor, where the control unit is arranged to determine a degree of concrete maturity associated with a segment of the concrete surface.

32. (canceled)

33. A concrete surface processing system comprising a plurality of instances of the concrete surface processing machine according to claim 1, the system comprising a central control unit communicatively coupled to the plurality of machines and arranged to control a floor grinding operation over a concrete surface.

34. (canceled)

35. A method for processing a concrete surface, the method comprising:
configuring one or more concrete surface processing machines, wherein each machine comprises a control unit and at least three tool carriers arranged to rotate about respective tool carrier axes, wherein at least one of the tool carriers is arranged to generate a variable force acting on the machine, relative to the concrete surface in response to a control signal generated by the control unit, wherein the control signal is configured to provide locomotion by the machine relative to the surface, deploying the plurality of machines over the concrete surface, and processing the concrete surface by the plurality of machines.

36. The method according to claim 35, wherein the processing comprises controlling the one or more machines by remote control or autonomously controlling each of the one or more machines.

37-44. (canceled)
